(19) United States
(12) Patent Application Publication
(10) Pub. No.: US 2012/0318380 A1
(43) Pub. Date: Dec. 20, 2012

(54) TURBOJET ENGINE NACELLE PROVIDED WITH A COOLING ASSEMBLY FOR COOLING A COMPONENT

(75) Inventors: Pascal Mer, Le Havre (FR); Jean-François Thouement, Toutainville (FR)

(73) Assignee: AIRCELLE, Gonfreville l'Orcher (FR)

(21) Appl. No.: 13/579,549

(22) PCT Filed: Feb. 3, 2011
(86) PCT No.: PCT/FR2011/050214

§ 371 Date: Aug. 16, 2012

(30) Foreign Application Priority Data
Mar. 3, 2010 (FR) 1051525

(51) Int. Cl. F02K 1/00

(52) U.S. Cl. 137/375

(57) ABSTRACT

The invention relates to a turbojet engine nacelle component (23) cooling assembly (30), said assembly (30) comprising at least one composite wall (20) separating a cold zone (8) and a hot zone (16) containing said component (23), said assembly (30) comprising at least one opening (31) made in said composite wall (20) and a thermally conductive interface element (33) positioned on the composite wall (20) in such a way as to obstruct said opening or openings (31), said element (33) being intended to be associated with said component (23). The invention also relates to a nacelle comprising a component (23) that is intended to be cooled, and to such a cooling assembly (30).

### TECHNICAL FIELD

The present invention relates to a cooling assembly for a turbojet engine nacelle, said assembly comprising at least one composite wall separating a cold zone and a hot zone comprising said component.

The present invention also relates to a turbojet engine nacelle including a component to be cooled and such a cooling assembly.

### BACKGROUND

An aircraft is moved by one or more turbojet engines each housed in a nacelle.

A nacelle generally has a tubular structure comprising an air inlet upstream of the turbojet engine, an intermediate assembly intended to surround a fan of the turbojet engine, a rear assembly that can incorporate thrust reversal means and intended to surround the combustion chamber and all or some of the compressor and turbine stages of the turbojet engine. The nacelle generally ends with a jet nozzle whereof the outlet is situated downstream of the turbojet engine.

Modern nacelles are intended to house a dual-flow turbojet engine capable of creating a hot air flow on the one hand, also called “primary flow,” coming from the combustion chamber of the turbojet engine, and circulating in a space delimited by a substantially tubular compartment called a “core compartment,” and on the other hand, a cold air flow, also called “secondary flow,” coming from the fan and circulating outside the turbojet engine through an annular passage, also called “tunnel,” formed between an internal structure defining a fairing of the turbojet engine and the external structure of the nacelle protecting the nacelle from the outside. The two flows of air are ejected from the turbojet engine through the rear nacelle.

Part of the walls of the nacelle separates a first zone, called “cold zone,” and a second zone, called “hot zone,” said cold zone being colder than said hot zone. Certain components located in the hot zone may be damaged by the thermal stress created by the temperature difference between the hot zone and the cold zone. In particular, this is the case for components such as damping and stopping devices, called “bumpers,” positioned in the core compartment of the nacelle on the wall of the inner fixed structure of the thrust reverser. Using a bumper makes it possible to limit the movement between the elements making up the inner fixed structure of the thruster reverser.

To ventilate such components, it is known to use dynamic scoops taking cold air from the cold zone and to protect the component using an enclosure of the sheet metal type. However, using a scoop assumes the removal of cold air, which decreases the thrust output of the nacelle.

Furthermore, in certain cases, the pressure from the cold air present in the cold zone is not always sufficient to cool the component. The components are then protected by a thermal enclosure made up of two sheets of stainless steel and an insulating material. The cooling may be reinforced by conduction, when the wall is made from a heat conducting material, such as aluminum.

However, to lighten the nacelle, many walls are made from a composite material such as epoxy or BMI. Cooling may therefore no longer be done by conduction, due to the low conductivity of the composite.

### BRIEF SUMMARY

One aim of the present invention is therefore to provide a cooling assembly for a turbojet engine nacelle comprising a composite wall separating a cold zone from a hot zone, said assembly being capable of effectively cooling a component positioned in the hot zone, without detriment to the thrust output of the nacelle.

To that end, according to a first aspect, the invention relates to a cooling assembly for a turbojet engine nacelle component, said assembly comprising at least one composite wall separating a cold zone and a hot zone comprising said component, characterized in that it has at least one opening formed in said composite wall and a heat conducting interface element positioned on the composite wall so as to cover said opening(s), said element being intended to be associated with said component.

The present invention provides a simple and effective way to cool any component positioned in the hot zone owing to the opening present in the wall that is covered by the heat conducting interface element, which allows the heat exchange with the component.

Furthermore, it is no longer necessary to use ventilation scoops or any other cooling device to cool the component and the composite wall. In this way, costs are limited and the thrust output of the nacelle is improved.

The present invention also allows savings in terms of the mass of the nacelle, since it is possible to use walls made from a composite material.

According to other features of the invention, the assembly according to the invention includes one or more of the following optional features, considered alone or according to all possible combinations:
the shape of the interface element is in aerodynamic continuity with the rest of the composite wall near the opening(s);
the interface element comprises ends configured to be fastened on the composite wall using fastening means;
the interface element is made from aluminum or any other material having a thermal conductivity at least equivalent to that of aluminum;
at least one shim is inserted between the ends of the interface element and the composite wall;
the interface element is covered with an enclosure made from a heat conducting material;
the heat conducting material is chosen from among aluminum or any other material having a heat conductivity at least equivalent to that of aluminum.

According to another aspect, the invention relates to a turbojet engine nacelle having at least one component and at least one cooling assembly according to the invention, said assembly being intended to cool said component.

Preferably, the composite wall of said assembly is the wall of a thrust reversal inner fixed structure.

Preferably, the interface element forms the support of a damping and stop device secured on the wall of the inner fixed structure, said device being intended to be mounted in the hot zone.

### BRIEF DESCRIPTION OF THE DRAWINGS

The invention will be better understood upon reading the following non-limiting description, done in reference to the appended figures:

FIG. 1 is a longitudinal cross-section of one embodiment of a nacelle according to the invention;

FIG. 2 is a simplified transverse cross-section of the nacelle of FIG. 1;

FIG. 3 is a perspective front view of one embodiment of a cooling assembly comprising a composite wall of the inner fixed structure of a nacelle and an interface element in the form of a support of a damping and stop device mounted on said wall;

FIG. 4 is a rear perspective view of the wall and the damping and stop device of FIG. 3;

FIG. 5 is a transverse cross-section of the embodiment of the cooling assembly of FIG. 3;

FIG. 6 is a transverse cross-section of an alternative of FIG. 5.

### DETAILED DESCRIPTION

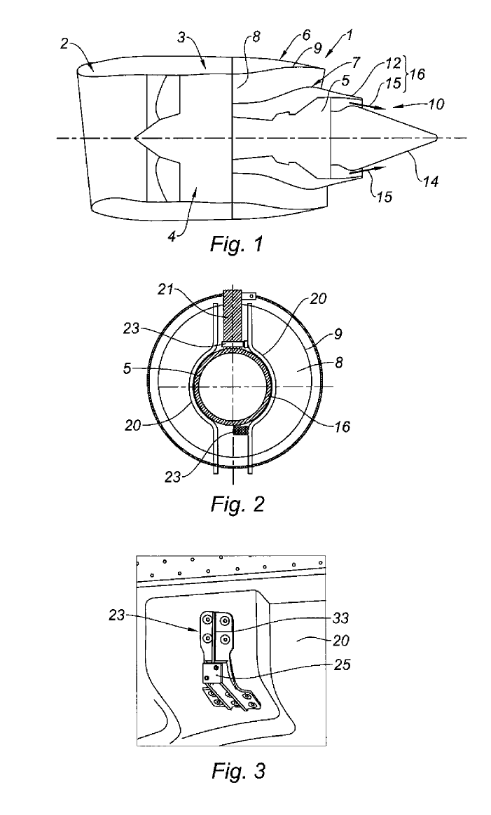

As shown in FIG. 1, a nacelle 1 according to the invention comprises an air intake lip 2, a middle structure 3 surrounding a fan 4 of a turbojet engine 5, and a downstream assembly 6. The downstream assembly 6 comprises an inner fixed structure 7 (IFS) surrounding the upstream portion of the turbojet engine 5, an outer fixed structure (OFS) 9, and a mobile cowl (not shown) including thrust reverser means.

The IFS 7 and OFS 9 delimit a tunnel 8 allowing the passage of a flow of cold air penetrating the nacelle 1 according to the invention at the air intake lip 2. The tunnel 8 corresponds to a cold zone. Typically, the temperature inside the tunnel 8 is between −50° C. and 100° C.

A suspension mast (not shown in FIG. 1) supports the turbojet engine 5 and the nacelle 1 according to the invention.

The nacelle 1 according to the invention ends with a jet nozzle 10 comprising an outer module 12 and an inner module 14. The inner 14 and outer 12 modules define a flow channel for the primary air flow 15, called the hot air flow, leaving the turbojet engine 5.

The core compartment 16 is defined as a hot zone comprising the turbojet engine 5 creating the circulation of the primary hot air flow and the flow channel of said primary air flow 15. The temperature inside the core compartment 16 is typically between 100° C. and 400° C. (to which the impact of the radiation from the engine casing, temperatures of up to 750° C., must be added). Said core compartment 16 is surrounded by the IFS 7.

More specifically, the IFS 7 is made up of the wall made from a composite material, in particular in the form of at least one panel. The wall of the IFS 7 thus separate a cold zone, the tunnel 8 in which a flow of cold air circulates, and a hot zone, the core compartment 16. The panel may be of the honeycomb type (NIDA) sandwiched between two composite layers that may be acoustically pierced on the cold zone side, i.e. the tunnel 8.

The composite material may be chosen from among a material comprising a mixture of carbon and epoxy or carbon and BMI or any other composite.

As illustrated in FIG. 2, the IFS 7 may be made from a multitude of structures articulated to one another, in particular two inner fixed half-structures in the 12 o'clock position when the nacelle 1 according to the invention is seen from the front, i.e. at the attachment mast 21 of the nacelle, and locked in the 6 o'clock position when the nacelle 1 according to the invention is seen from the front, i.e. diametrically opposite the location of said pylon 21. The wall 20 of each half-structure therefore separate a cold zone 8 from a hot zone 16.

The IFS 7 typically includes at least one damping and stop device 23, also called “bumper,” making it possible to limit the movement of the two inner fixed half-structures, in particular of the walls 20. In fact, mechanical stresses exist in particular at the 6 o'clock and 12 o'clock positions, driving movements of said walls 20 of the inner fixed half-structures.

A plurality of damping and stop devices 23 may be installed in the 6 o'clock position and the 12 o'clock position, in particular three in the 6 o'clock position and three in the 12 o'clock position.

As shown in FIG. 3, each damping and stop device 23 comprises a head 25 configured to abut against another stop mounted on the wall 20 of one of the two inner half-structures. The head 25 is mounted on a support 27 secured on said wall 20 of the inner half-structure.

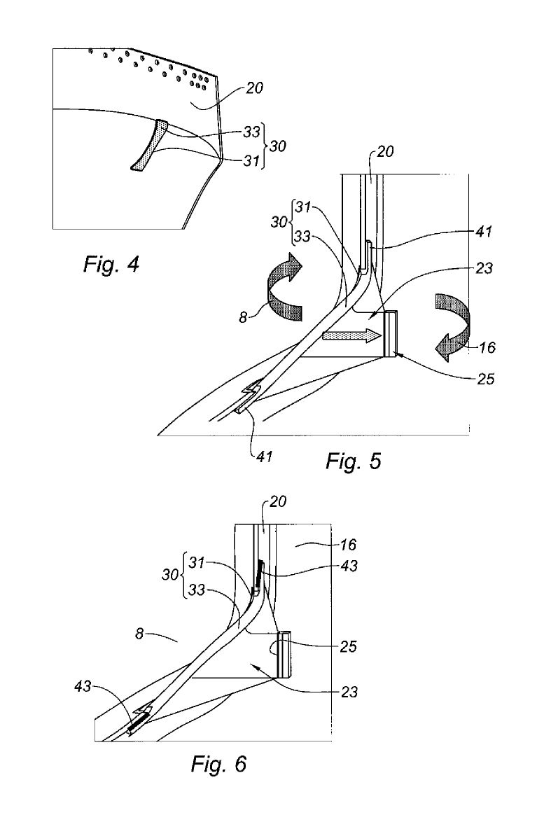

According to the invention and as shown in FIGS. 3 to 5, the cooling assembly 30 of the invention comprises at least one composite wall 20 in which at least one opening 31 is formed, and a heat conducting interface element 33 is positioned on the wall so as to cover said opening 31, said heat conducting element 33 being associated with the component to be cooled, in the case at hand, the device 23.

In alternatives, the component may also be any nacelle and/or engine equipment installed in a hot zone close to a cold zone.

The cold zone 8 is typically colder than the hot zone 16. In other words, the average temperature of the cold zone 8 is below the average temperature of the hot zone 16.

The present invention thus makes it possible to simply and effectively cool a component 23 positioned in a hot zone 16, here the core compartment, associated with a heat conducting element 33 that allows a heat exchange intended to cover one or more openings 31 present in the composite wall 20.

Furthermore, it is no longer necessary to use ventilation scoops or any other expensive, heavy and bulky cooling device to cool the component 23. In this way, costs are limited and the thrust output of the nacelle 1 according to the invention is improved. In fact, the flow circulating in the cold zone, the tunnel 8, is not disrupted by the presence of such a cooling assembly 30.

The present invention also allows savings in terms of the mass of the nacelle 1 according to the invention, since it is possible to use composite walls making it possible to cool components.

The interface element 33 may be attached on said component 3 or be formed in a single piece therewith. Thus, in the case of a damping and stop device 23, the interface element 33 can form the support 27, which is configured to cover said opening(s) 31.

In FIGS. 3 to 6, the assembly 30 according to the invention comprises a single opening 31. It is possible for said assembly 30 to have a plurality of openings 31.

Said opening(s) 31 may assume any shape and size. In particular, the interface element 33 can cover a single opening 31 with a size substantially equal to or slightly smaller than that of the interface element 33 (see FIG. 5). In one alternative that is not illustrated, the interface element may also cover a plurality of openings much smaller than those of the interface element.

Preferably, the shape of the interface element 33 may be in aerodynamic continuity with the rest of the composite wall 20. In this way, advantageously, the flow of air circulating in the cold zone 8 is not disrupted by the presence of the interface element 33.

The interface element 33 may be made from a heat conducting material chosen from among aluminum or any other material having a heat conductivity at least equivalent to that of aluminum.

The interface element 33 can comprise ends 41 configured to be fastened on the composite wall 20 of each fixed half-structure by fastening means. The ends 41 may have a shape substantially complementary to the surface of the composite wall 20 on which said ends 41 are intended to be fastened. The fastening means maybe of the permanent, screwed or blind type and have burred heads, in particular approximately ten burred heads.

According to one embodiment illustrated in FIG. 6, at least one shim 43 is inserted between the ends 41 of the interface element and the composite wall 20. The presence of the shim 43 makes it possible to absorb any aerodynamic defect. The shim 43 may be made from aluminum, titanium or steel and using a strippable, mixed or solid method.

According to one alternative, the interface element 33 may be protected by an enclosure made from a heat conducting material of the stainless steel covering type. As a result, it is possible to avoid an excessive temperature increase within the interface element 33, which makes it possible to regulate the heat in the latter more easily.

The heat conducting material may be chosen from among aluminum or any other material having a heat conductivity at least equivalent to that of aluminum.

1. A turbojet engine nacelle having a thrust reverser inner fixed structure, at least one component to be cooled and at least one cooling assembly to cool said component, said assembly comprising at least one composite wall forming the inner fixed structure and separating a cold zone and a hot zone comprising said component, characterized in that the cooling assembly has at least one opening formed in said composite wall and a heat conducting interface element positioned on the composite wall so as to cover said opening(s), said element being intended to be associated with said component.

2. The nacelle according to claim 1, wherein the shape of the interface element is in aerodynamic continuity with the rest of the composite wall near the opening(s).

3. The nacelle according to claim 1, wherein the interface element comprises ends configured to be fastened on the composite wall using fastening means.

4. The nacelle according to claim 1, wherein the interface element is made from aluminum or any other material having a thermal conductivity at least equivalent to that of aluminum.

5. The nacelle according to claim 1, wherein at least one shim is inserted between the ends of the interface element and the composite wall.

6. The nacelle according to claim 1, wherein the interface element is covered with an enclosure made from a heat conducting material.

7. The nacelle according to the preceding claim, wherein the heat conducting material is chosen from among aluminum or any other material having a heat conductivity at least equivalent to that of aluminum.

8. The nacelle according to claim 1, wherein the interface element forms the support for a damping and stop device fastened on the wall of the inner fixed structure, the device being intended to be mounted in the hot zone.
